(19) United States
(12) Patent Application Publication
(10) Pub. No.: US 2010/0088001 A1
(43) Pub. Date: Apr. 8, 2010

(54) VEHICULAR CRUISE CONTROL APPARATUS

(75) Inventor: Ryoji Kato, Kawasaki-shi (JP)

Correspondence Address: ROSSI, KIMMS & McDOWELL LLP., 20609 Gordon Park Square, Suite 150, Ashburn, VA, 20147, US

(73) Assignee: MITSUBISHI FUSO TRUCK AND BUS CORPORATION, Kawasaki-shi, Kanagawa (JP)

(21) Appl. No.: 12/531,201

(22) PCT Filed: Mar. 27, 2008
(86) PCT No.: PCT/JP2008/055899

§ 371 Date: Oct. 1, 2009

(30) Foreign Application Priority Data
Mar. 28, 2007 (JP) 2007-083872

(51) Int. Cl. B60W 30/14

(52) U.S. Cl. 701/93

(57) ABSTRACT

The object is to allow a vehicle at a constant target cruising speed without making the occupants feel discomfort.

A vehicular cruise control apparatus controlling a speed of a vehicle to be at a target cruising speed, the vehicular cruise control apparatus including: a first auxiliary brake (12,13 and/or 14) applying braking force in a stepwise manner to the vehicle; an acceleration detector (25) obtaining acceleration of the vehicle; an auxiliary brake actuator (25) activating the first auxiliary brake (12,13 and/or 14) if the acceleration (α) obtained by the acceleration detector (28) is greater than a first threshold (α_{TH1}); a speed detector (15) obtaining the speed of the vehicle; and a threshold adjustor (27) decreasing the first threshold (α_{TH1}) according to increase of the speed of the vehicle detected by the speed detector (15).

### TECHNICAL FIELD

The present invention relates to a vehicular cruise control apparatus, that is, a so-called cruise control apparatus.

### BACKGROUND

There has conventionally been developed a technology relative to a cruise control apparatus which controls a vehicle to maintain a constant speed. The cruise control apparatus controls braking force generated by the driving force and the braking force of the engine and thereby causes the vehicle to drive at a constant target cruising speed set by the driver.

There has been known a technique, for large-sized vehicles, such as buses and trucks, that use the above cruise control apparatus that aims at cruising at a constant speed by controlling an auxiliary brake.

Such a technique is exemplified by that disclosed in the following Patent Reference 1.

In the technique of the Patent Reference 1, if the vehicle in execution of cruising at a constant speed (i.e., in autocruise) is judged to be accelerating contrary to the driver's intention, the braking force generated by an auxiliary brake is stepwisely increased.
[Patent Reference 1] Japanese Patent Application Lai-Open (KOKAI) No. HEI 8-282329

### DISCLOSURE OF INVENTION

### Problems to be Solved by Invention

However, in the technique of the Patent Reference 1, the deceleration of the vehicle may sometimes become excessively large or excessively small, so that the occupants of the vehicle feel discomfort.

For example, comparing activation of an auxiliary brake responsive to a judgment of acceleration of a vehicle cruising at a relatively low speed (e.g., 70 km/h) with the same activation of the auxiliary brake responsive to a judgment of acceleration of a vehicle cruising at a relatively high speed (e.g., 120 km/h), the occupants feel large deceleration in the former case and small deceleration in the latter case.

Specifically, assuming that the threshold to be used for judgment of acceleration is set with respect to a case where autocruise is executed under setting of a relatively low target cruising speed in the Patent Reference 1, the actual vehicle speed tends to overshoot a target cruising speed if autocruise is being executed while the target cruising speed is set to be relatively high.

In contrast, assuming that the threshold to be used for judgment of acceleration is set with respect to a case where autocruise is executed under setting of a relatively high target cruise speed, the actual vehicle speed tends to undershoot a target cruising speed if autocruise is being executed while the target cruising speed is set to be relatively low.

This is because the auxiliary brake is set not to be relatively easily activated in the former case but relatively easily activated in the latter case.

Such overshooting and undershooting causes the occupants discomfort.

With the foregoing problems in view, the object of the present invention is to provide a vehicular cruise control apparatus that controls a vehicle to cruise at a constant target cruising speed without making the occupants feel discomfort.

### Means to Solve the Problem

To attain the above object, there is provided a vehicular cruise control apparatus controlling a speed of a vehicle to be at a target cruising speed, the vehicular cruise control apparatus including: a first auxiliary brake applying braking force in a stepwise manner to the vehicle; an acceleration detector obtaining acceleration of the vehicle; an auxiliary brake actuator activating the first auxiliary brake if the acceleration obtained by the acceleration detector is greater than a first threshold; a speed detector obtaining the speed of the vehicle; and a threshold adjustor decreasing the first threshold according to increase of the speed of the vehicle detected by the speed detector.

### EFFECTS OF INVENTION

The vehicular cruise control apparatus of the present invention can cruise the vehicle at a constant target cruising speed without making the occupants feel discomfort.

### BRIEF DESCRIPTION OF DRAWINGS

FIG. 1

A block diagram schematically showing the entire configuration of a vehicular cruise control apparatus according to a first embodiment of the present invention;

FIG. 2

A table schematically showing control by an auxiliary brake in the vehicular cruise control apparatus of the first embodiment;

FIG. 3

A diagram schematically showing an auxiliary brake control map of the vehicular cruise control apparatus of the first embodiment; and

FIG. 4

A flow diagram schematically showing control performed in the vehicular cruise control apparatus of the first embodiment.

### DESCRIPTION OF REFERENCE NUMBERS

12 exhaust valve (first and/or second auxiliary brakes)
13 fluid retarder (first and/or second auxiliary brakes)
15 speed sensor
14 engine brake valve (first and/or second auxiliary brakes)
25 acceleration calculator (acceleration detector)
27 auxiliary brake control map 27 [sic] (threshold adjustor)
28 auxiliary brake actuator
29 auxiliary brake keeper
α_{TH1} first threshold
α_{TH2} second threshold

### BEST MODE TO CARRY OUT THE INVENTION

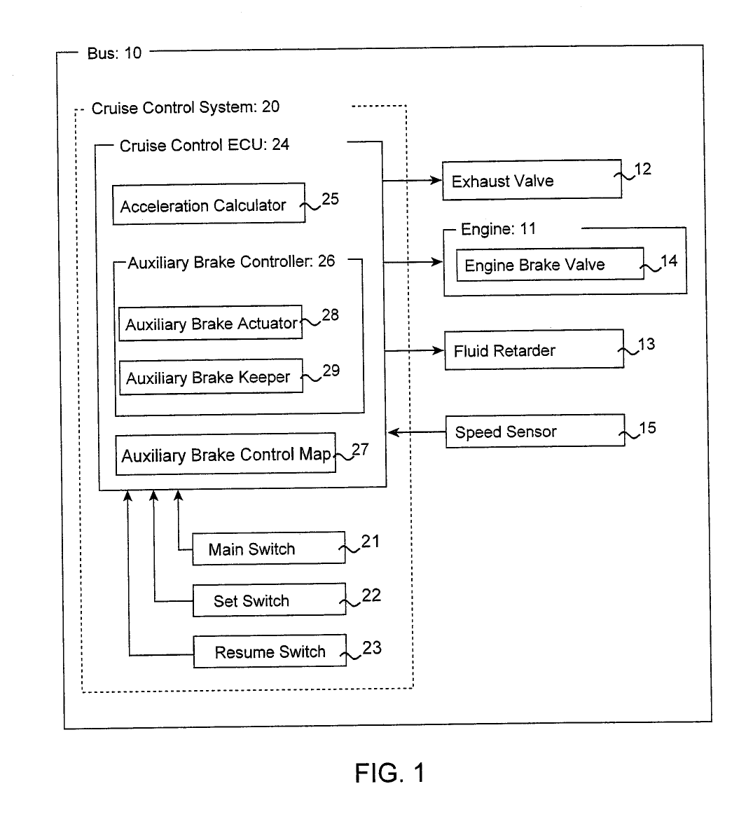

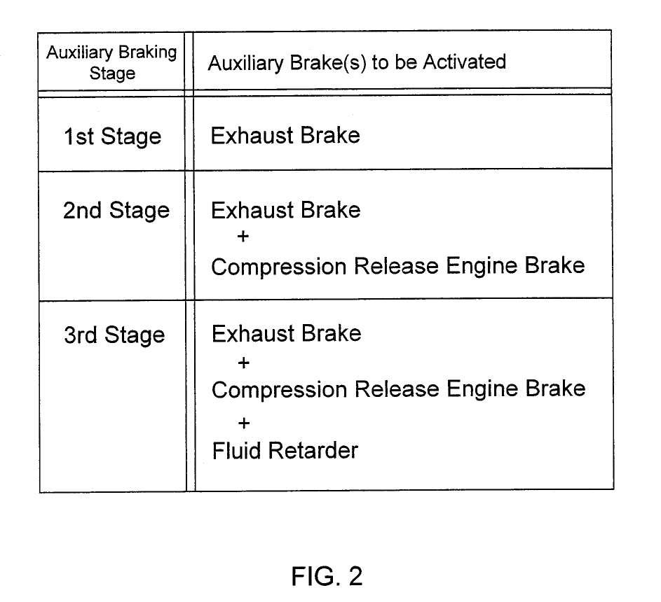

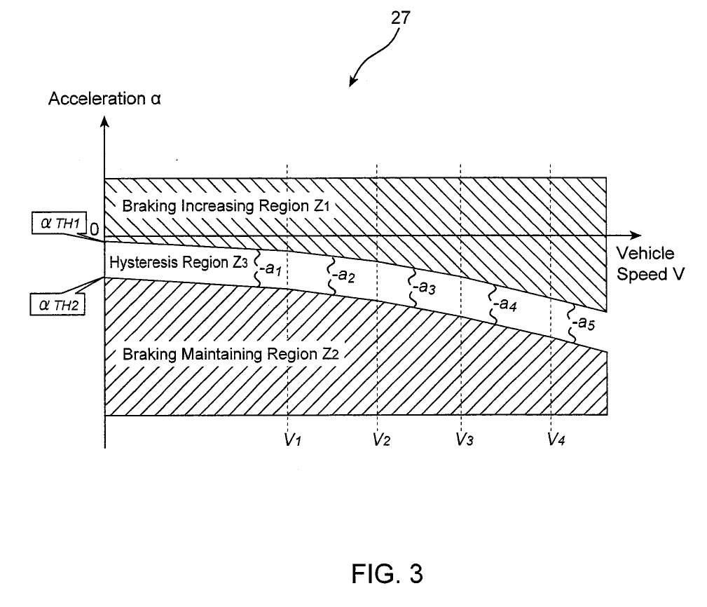

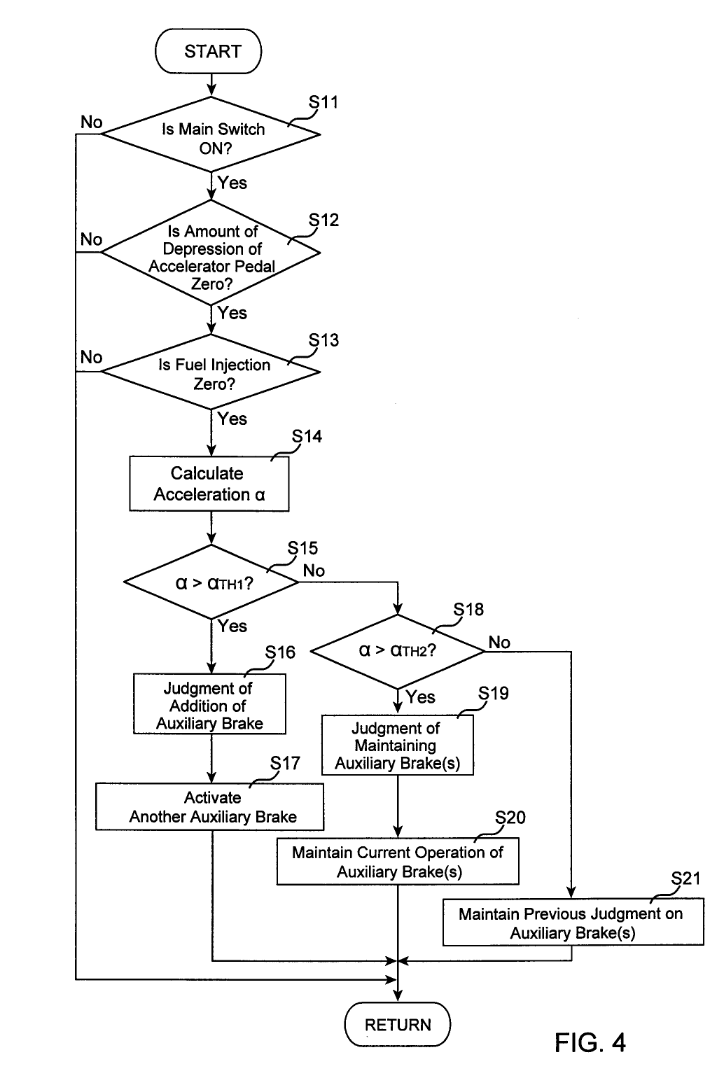

Hereinafter, description will now be made in relation to a vehicular cruise control apparatus according to a first embodiment of the present invention with reference to accompanying drawings. FIG. 1 is a block diagram schematically showing the entire configuration of a vehicular cruise control apparatus; FIG. 2 is a table schematically showing control by an auxiliary brake; FIG. 3 is a diagram schematically showing an auxiliary brake control map; and FIG. 4 is a flow diagram schematically showing control performed in the apparatus.

As shown in FIG. 1, a diesel engine (engine) 11 is mounted on a bus (vehicle) 10 to serve as a driving power source.

The bus 10 further includes, in addition to a main brake (not shown) that brakes the wheels (not shown) in accordance with an amount of depression of a brake pedal (not shown), an exhaust valve 12, a fluid retarder 13, and an engine brake valve 14, which serves as auxiliary brakes (each serving as a first or second auxiliary brake).

The exhaust valve 12 activates a so-called exhaust brake, and is arranged inside an exhaust pipe (not shown) connected to the engine 11. Closing the exhaust valve 12 by an exhaust valve actuator (not shown) restricts flow of exhaust gas thereby resisting the revolution of the engine 11. The exhaust valve 12 is selectively in a state of “open” and “closed”, so that the exhaust brake is selectively on/off controlled.

The fluid retarder 13 includes a rotor (not shown) revolving in combination with a propeller shaft (not shown) arranged in the bus 10, and a stator (not shown) fixed to the housing (not shown) of the fluid retarder 13. Filling the space between the rotor and stator with operation oil restricts the revolution of the propeller shaft to generate braking force. The fluid retarder 13 is also selectively on/off controlled.

The engine brake valve 14 is an exhaust valve arranged independently of a general exhaust valve (not shown) positioned in the engine 11, and activates the compression release engine brake. The engine brake valve 14 is driven by an engine brake valve actuator (not shown). Here, the compression release engine brake generates the braking force by temporarily releasing (opening) the engine brake valve 14 between the compression stroke and the expansion stroke to restrict the revolution of the engine 11. The compression release engine brake is also selectively on/off controlled.

The bus 10 further includes a speed sensor 15 that obtains the vehicle speed V, and an accelerator pedal position sensor (not shown) that obtains an amount of depression of the accelerator pedal (not shown). The results obtained by the speed sensor 15 and the accelerator pedal position sensor are read by a cruise control ECU 24 that is to be detailed below.

Further, the bus 10 includes a cruise control system 20.

The cruise control system 20 includes a main switch 21, a set switch 22, a resume switch 23, and cruise control ECU (Electronic Control Unit) 24.

The main switch 21 is used to turn on/off the operation of the cruise control ECU 24.

The set switch 22 is used to set the target speed (target cruising speed).

The resume switch 23 is used to resume autocruise which has been temporarily interrupted.

The cruise control ECU 24 is an electronic control unit with an interface, a memory and a CPU, which do not however appear in the drawings.

In the memory of the cruise control ECU 24, an acceleration calculator (acceleration detector) 25 and an auxiliary brake controller 26 both in the form of software are stored, and an auxiliary brake control map (threshold adjustor) 27 is also stored.

The acceleration calculator 25 differentiates the vehicle speed V obtained by the speed sensor 15 to calculate acceleration α of the bus 10.

The auxiliary brake controller 26 controls three auxiliary brakes, i.e., the exhaust brake, the fluid retarder, and the compression release engine brake, and includes subprograms serving as an auxiliary brake actuator 28 and auxiliary brake keeper 29.

The auxiliary brake actuator 28 activates the above three auxiliary brakes in the event of judging that large deceleration is required.

In detail, if activation of one or more of the auxiliary brakes has come to be required while all the auxiliary brakes are not activated, the auxiliary brake actuator 28 first closes the exhaust valve 12 to turn on the exhaust brake as in the “first stage” of FIG. 2.

After turning on the exhaust brake, if further deceleration is judged to be required, the auxiliary brake actuator 28 activates the compression release engine brake in addition to the exhaust brake. Specifically, the auxiliary brake actuator 28 closes the exhaust valve 12, and simultaneously opens the engine brake valve 14 temporarily between the compression stroke and the expansion stroke to restrict the revolution of the engine 11 (the second stage).

Despite the operation of the exhaust brake and the compression release engine brake, if further deceleration is judged to be required, the auxiliary brake actuator 28 activates the fluid retarder 13 in addition to turning on the exhaust brake and the compression release engine brake. Thereby, the auxiliary brake actuator 28 closes the exhaust valve 12; opens the engine brake valve 14 temporarily between the compression stroke and the expansion stroke; and fills the space between the rotor and stator in the fluid retarder 13 with operation oil to restrict the revolution of the propeller shaft (the third stage).

The auxiliary brake keeper 29 maintains the current operation of one or more auxiliary brakes which are currently in operation, in other words, maintains the auxiliary braking stages shown in FIG. 2 when it is judged that no large deceleration is required but current deceleration is required to be maintained.

Here, description will now be made in relation to the judgment that “large deceleration is required” and the judgment that no large deceleration is required but current deceleration is required to be maintained which judgments are made by the auxiliary brake actuator 28 and the auxiliary brake keeper 29, respectively.

These judgments are made with reference to the auxiliary brake control map 27 shown in FIG. 3.

On the auxiliary brake control map 27, the ordinate represents the acceleration α and the abscissa represents the vehicle speed V. Further, a braking increasing region Z₁, a braking maintaining region Z₂, and a hysteresis region Z₃ between the braking increasing region Z₁ and the braking maintaining region Z₂ are determined.

An acceleration (first threshold) α_{TH1} at the boundary between the braking increasing region Z₁ and the hysteresis region Z₃ is defined so as to decrease in accordance with increase in the vehicle speed V.

Similarly, an acceleration (second threshold) α_{TH2} at the boundary between the hysteresis region Z₃ and the braking maintaining region Z₂ is defined so as to decrease in accordance with increase in the vehicle speed V.

The first threshold α_{TH1} and the second threshold α_{TH2} are set to be the same in gradient.

In FIG. 3, the specific vehicle speeds V₁, V₂, V₃ and V₄ have the relationship shown in the following expression (1).

V₁<V₂<V₃<V₄ (1)

The gradient of the first threshold α_{TH1} and the second threshold α_{TH2} is defined to be −a₁ between the vehicle speeds zero and V₁; −a₂ between the vehicle speeds V₁ and V₂; −a₃ between the vehicle speeds V₂ and V₃; −a₄ between the vehicle speeds V₃ and V₄; and −a₅ at the vehicle speed in excess of V₄.

The gradients −a₁, −a₂, −a₃, −a₄, and −a₅ have the relationship shown in the following expression (2).

|a₁|<|a₂|<|a₃|<|a₄|<|a₅| (2)

These gradients −a₁, −a₂, −a₃, −a₄, and −a₅ are common to the first threshold α_{TH1} and the second threshold α_{TH2}.

When the acceleration α and the vehicle speed V are in the braking increasing region Z₁, the auxiliary brake actuator 28 judges that “large deceleration is required”.

When the acceleration α and the vehicle speed V are in the braking maintaining region Z₂, the auxiliary brake actuator 28 judges that “large deceleration is not required but the current deceleration is required to be maintained”.

When the acceleration α and the vehicle speed V are in the hysteresis region Z₃, the operation by the auxiliary brake actuator 28 or the auxiliary brake keeper 29 is maintained without modification. Namely, at the time the acceleration α and the vehicle speed V come into the hysteresis region Z₃, if the auxiliary brake actuator 28 is in operation, the auxiliary brake actuator 28 is kept operating; conversely if the auxiliary brake keeper 29 is operating, the auxiliary brake keeper 29 is kept operating.

Defining the hysteresis region Z₃ between the braking increasing region Z₁ and the braking maintaining region Z₂ prevents judgment made by the auxiliary brake actuator 28 and judgment made by the auxiliary brake keeper 29 from frequently alternating in a short time.

With the above configuration, the vehicular cruise control apparatus of the first embodiment provides the following effects and advantages.

As shown in FIG. 4, when the main switch is on (Yes route in step S11), the amount of depression of the accelerator pedal obtained by the accelerator pedal position sensor is zero (Yes route in step S12), and when the amount of fuel injection is zero (Yes route in step S13), the acceleration calculator 25 calculates acceleration α (step S14).

If the acceleration α calculated in step S14 is larger than the first threshold α_{TH1}, in other words, if the acceleration α and the vehicle speed V are in the braking increasing region Z₁ (Yes route in step S15), addition of auxiliary brake is judged (step S16). Namely, the auxiliary brake actuator 28 judges that “large deceleration is required.”

After that, the auxiliary brake actuator 28 raises the auxiliary braking stage shown in FIG. 2 by one and consequently activates an additional auxiliary brake (step S17).

Conversely, if the acceleration α is judged to be smaller than the first threshold α_{TH1} in step S15 (No route in step S15), judgment as to whether or not the acceleration α is smaller than the second threshold α_{TH2} is made (step S18).

If the acceleration α is judged to be smaller than the second threshold α_{TH2}, in other words, if the acceleration α and the vehicle speed V are judged to be in the braking maintaining region Z₂ (Yes route in step S18), maintaining of auxiliary brake is judged (step S19). Namely, in this case, the auxiliary brake keeper 29 judges that “large deceleration is not required but the current deceleration is required to be maintained”.

After that, the auxiliary brake keeper 29 maintains the current auxiliary braking step shown in FIG. 2 (step S20).

If the acceleration α is judged to be larger than the second threshold α_{TH2} in step S18, in other words, if the acceleration α and the vehicle speed V are judged to be in the hysteresis region Z₃ (No route in step S18), the previous judgment on the auxiliary brakes is maintained. In other words, if the auxiliary brake actuator 28 is operating, the auxiliary brake actuator 28 is kept operating; and if the auxiliary brake keeper 29 is operating, the operation of the auxiliary brake currently in operation is maintained.

If the main switch 21 is off (No route in step S11), the accelerator pedal is depressed (No route in step S12), or the engine 11 injects the fuel (No route in step S13), the procedure returns.

According to the vehicular cruise control apparatus of the first embodiment, a manner of activating the auxiliary brakes is appropriately varied depending on the vehicle speed V, so that the vehicle can cruise at the constant target cruise speed without making the occupants feel discomfort.

Since the braking force generated by the auxiliary brakes can be stepwisely intensified in accordance with the acceleration α and the vehicle speed V, the vehicle can more precisely cruise at the constant target cruise speed. Since the braking force generated by the auxiliary brakes can be maintained in accordance with the acceleration α and the vehicle speed V, the vehicle can more precisely cruise at the constant target cruise speed.

Here, the present invention will be detailed comparing the present invention with the conventional technique described in the field of the above background technique.

The braking force generated by an auxiliary brake such as an exhaust brake, a fluid retarder, and a compression release engine brake is stepwisely controlled, but is not linearly controlled as performed on the braking force of a general main brake.

The technique of Patent Reference 1 described in the background technique sets a trigger to activate an auxiliary brake irrespective of the vehicle speed during execution of autocruise.

Therefore, if a trigger to activate an auxiliary brake is set with respect to a vehicle cruising at 120 km/h in the technique of Patent Reference 1, the auxiliary brake is activated with an excessively high frequency during the execution of autocruise at 70 km/h which is set as the constant target cruising speed.

Namely, if a trigger to activate an auxiliary brake is determined with respect to a vehicle cruising at a relatively high speed (e.g., 120 km/h), the auxiliary brake tends to be relatively easily activated. This is because activation of an auxiliary brake at a high speed region takes a relatively long time to decelerate to a target cruising speed.

It is possible for a general main brake to appropriately increase or decrease the braking force so that time to decelerate the vehicle to a target cruising speed becomes constant. An auxiliary brake, which is on/off controlled, cannot use the above manner as performed by a main brake.

In contrast, the present invention determines a trigger to activate an auxiliary brake focusing on not only acceleration α but also a vehicle speed V, so that the behavior of the vehicle during execution of autocruise can be stabilized and the vehicle can cruise at the constant target cruise speed without making the occupants feel discomfort.

The present invention is described as above, but is not limited to the foregoing embodiment. Various changes and modifications can be suggested without departing from the gist of the invention.

In the above first embodiment, the diesel engine 11 serves as the driving power source and is mounted on the bus 10. But the present invention is not limited to this. Alternatively, a gasoline engine, an electric motor, a hydraulic motor, or combination of an engine and an electric motor may serve as the driving source.

The above first embodiment assumes that the vehicle is the bus 10. However, the vehicle is not limited to this. Any vehicle, such as a passenger car or a truck, at least including an auxiliary brake can be applied, and the kind of vehicle is not limited.

In the first embodiment, the auxiliary brakes are the exhaust brake, the fluid retarder, and the compression release engine brake, to which the present invention does not limit the auxiliary brakes. Alternatively, one or two of three these auxiliary brakes may be used, and four or more auxiliary brakes may be used in combination.

In the above first embodiment, the bus 10 is assumed to include the fluid retarder 13, which may alternatively be replaced with an electric resistance retarder.

What is claimed is:

1. A vehicular cruise control apparatus controlling a speed of a vehicle to be at a target cruising speed, said vehicular cruise control apparatus comprising:
a first auxiliary brake applying braking force in a stepwise manner to the vehicle;
an acceleration detector obtaining acceleration of the vehicle;
an auxiliary brake actuator activating said first auxiliary brake if the acceleration obtained by said acceleration detector is greater than a first threshold; and
a speed detector obtaining the speed of the vehicle;
a threshold adjustor decreasing the first threshold according to increase of the speed of the vehicle detected by said speed detector.

2. The vehicular cruise control apparatus according to claim 1, further comprising:
a second auxiliary brake, which is included in the vehicle independently of said first auxiliary brake, applying the braking force in a stepwise manner to the vehicle;
wherein,
said auxiliary brake actuator further activates said second auxiliary brake if the vehicular acceleration is greater than the first threshold during the operation of said first auxiliary brake.

3. The vehicular cruise control apparatus according to claim 2, wherein,
said auxiliary actuator includes
an auxiliary brake keeper maintaining, if the acceleration of the vehicle obtained by said acceleration detector is smaller than a second threshold which is smaller than the first threshold, said first auxiliary brake and said second auxiliary brake which are already in operation.
